(19) United States
(12) Patent Application Publication
(10) Pub. No.: US 2008/0011046 A1
(43) Pub. Date: Jan. 17, 2008

(54) Displacement Method for Determining the Spring Constant of Scanning Probe Microscope Cantileers using MEMS Actuators

(76) Inventors: Richard K. Workman, Los Altos, CA (US); Storrs T. Hoen, Brisbane, CA (US); George M. Clifford, Los Altos Hills, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/458,012

(22) Filed: Jul. 17, 2006

(51) Int. Cl. G12B 21/00

(52) U.S. Cl. 73/1.89; 73/1.79

(57) ABSTRACT

In accordance with the invention, the spring constant of a scanning probe microscope cantilever mechanically coupled to a MEMs actuator may be determined in-situ using a displacement method.

### CROSS REFERENCE TO RELATED APPLICATIONS

This application relates to the co-pending application Ser. No. ______ (Attorney Reference No. 10060075-1), filed on the same day entitled “Resonance Method for Determining the Spring Constant of Scanning Probe Microscope Cantilevers using MEMS Actuators” by Workman and Hoen, and Ser. No. (Attorney Reference No. 10060542-1), filed on the same day entitled “Force Method for Determining the Spring Contact of Scanning Probe Microscope Cantilevers using MEMS Actuators” by Workman, Hoen and Clifford, both owned by the assignee of this application and both incorporated herein by reference.

### BACKGROUND

Typically, it is difficult to measure the vertical and lateral spring constant of scanning probe microscope cantilevers accurately. The typical method of calibrating scanning probe microscope (SPM) cantilevers is the “Sader method”, described, for example, by Sader, Chon and Mulvaney in “Calibration of rectangular atomic force microscopy cantilevers”, Review of Scientific Instruments, 70(10), p. 3967, 1999 or by Cain et al. in “Force calibration in lateral force microscopy”, Journal of Colloid and Interface Science 227, p. 55, 2000. The “Sader method uses the length, width, resonance frequency, and quality factor, Q, of the scanning probe microscope cantilever to determine the spring constant. The “Sader method” does not depend on the optical lever sensitivity calibration.

Other methods for determining the spring constant include the thermal power spectral density method described by Hutter and Bechhoefer in “Calibration of atomic-force microscope tips”, Review of Scientific Instruments, 64(7), p. 1868, 1993; the “Cleveland method”, described by Cleveland in “A non-destructive method for determining the spring constant of cantilevers for scanning force microscopy”, Review of Scientific Instruments, 64, p. 403, 1993; and the torsional MEMS method, described by Cumpson et al. in “Microelectromechanical system device for calibration of atomic force microscope cantilever spring constants between 0.01 and 4 N/m”, Journal of Vacuum Science and Technology A, 22(4), p. 1444, 2004.

### SUMMARY

In accordance with the invention, the spring constant of a scanning probe microscope cantilever mechanically coupled to a MEMs actuator may be determined in-situ using a displacement method.

### BRIEF DESCRIPTION OF THE DRAWINGS

FIG. 1a shows a scanning probe cantilever attached to the electrostatic MEMS motor rotor of an electrostatic MEMS motor in accordance with the invention.

FIG. 1b shows a scanning probe microscope cantilever attached to the electrostatic MEMS motor rotor in contact with a surface in accordance with the invention.

FIG. 1c shows a scanning probe microscope cantilever attached to the electrostatic comb drive rotor of an electrostatic comb drive in accordance with the invention.

FIG. 1d shows a scanning probe microscope cantilever attached to the electrostatic comb drive rotor in contact with a surface in accordance with the invention.

FIG. 1e shows the sensor position versus vertical probe position.

FIG. 2a shows the force versus position for an electrostatic comb drive in accordance with the invention.

FIG. 2b shows the force versus position for an electrostatic MEMS motor in accordance with the invention.

FIG. 3a shows an embodiment in accordance with the invention.

FIG. 3b shows an embodiment in accordance with the invention.

FIG. 4 shows a spring of the electrostatic MEMS motor rotor in accordance with the invention.

### DETAILED DESCRIPTION

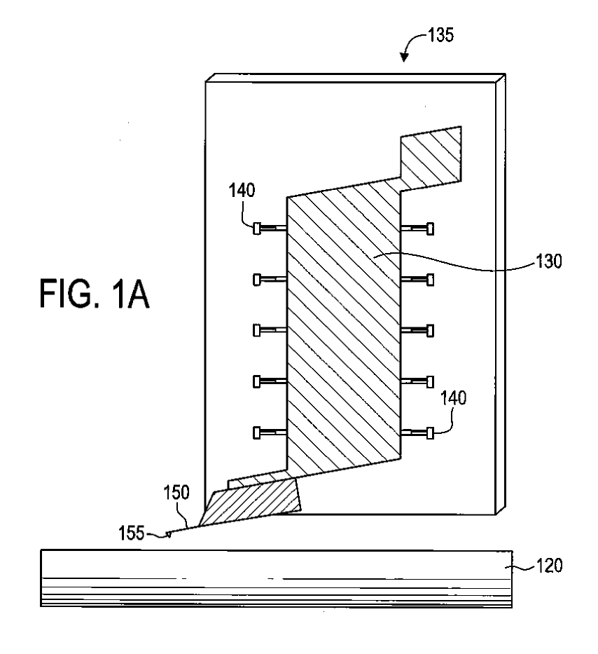

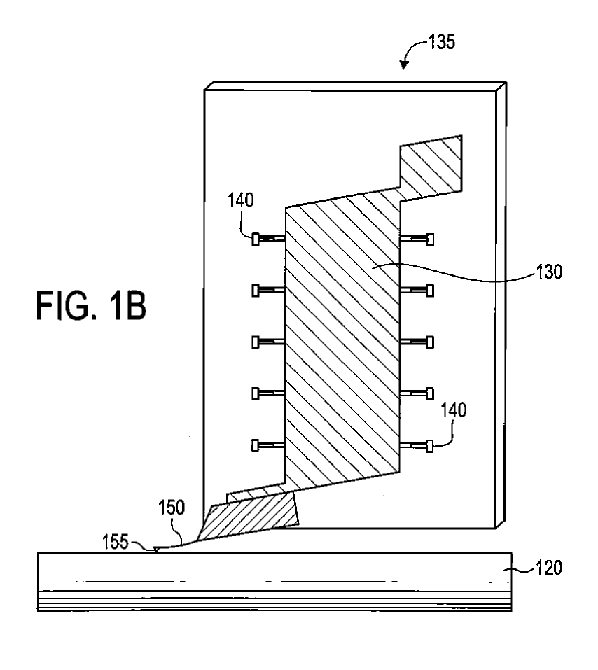

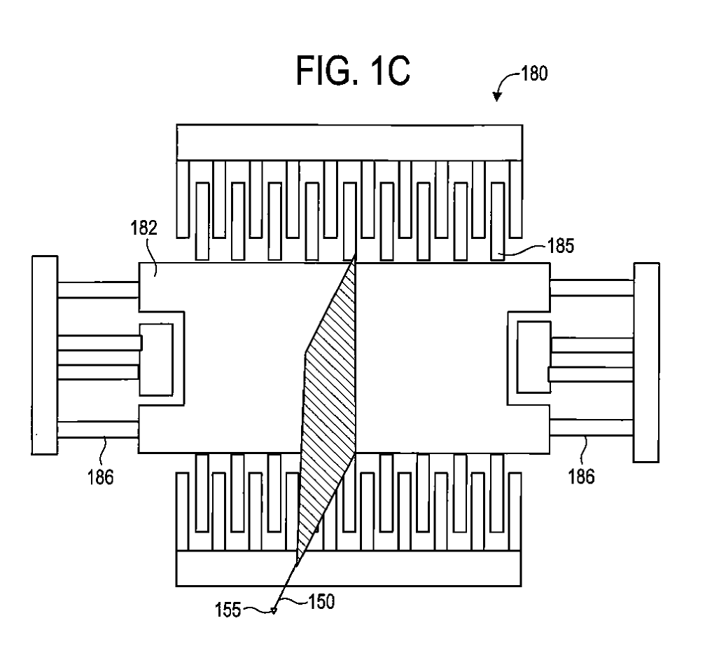

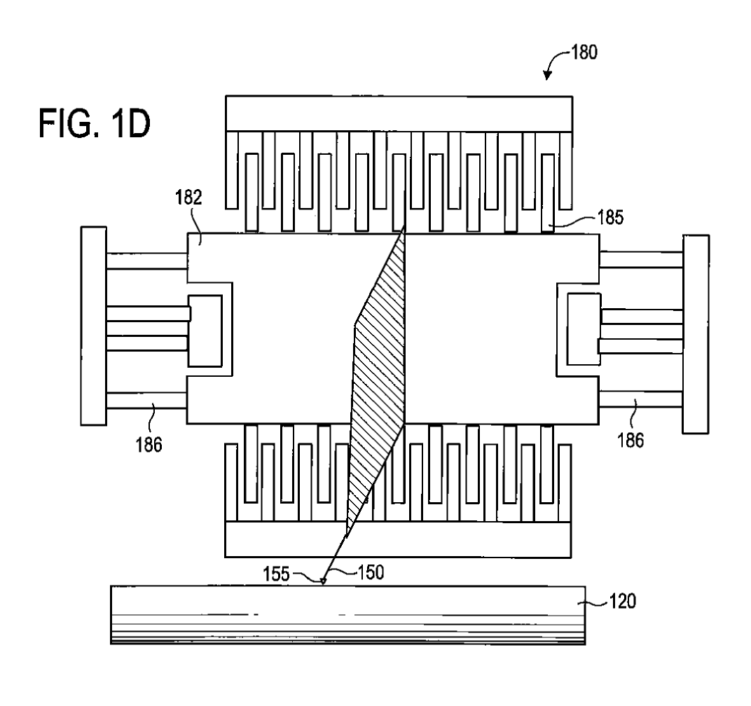

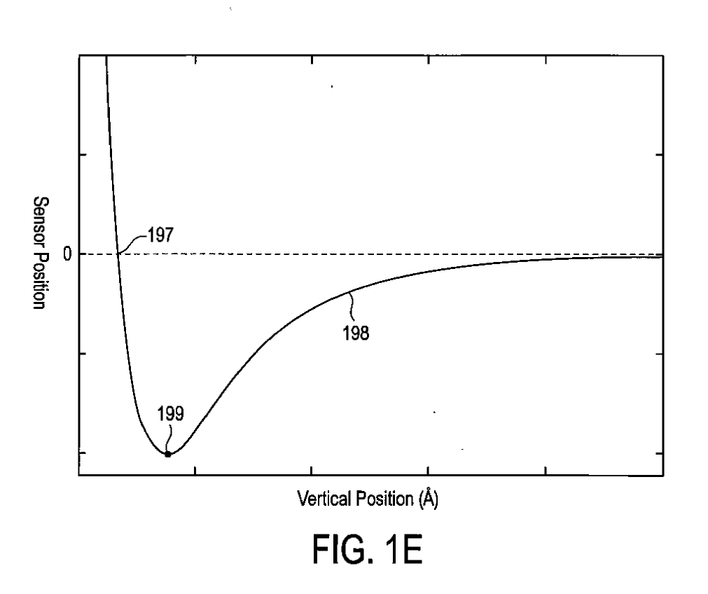

FIG. 1a shows scanning probe microscope cantilever 150 attached to electrostatic MEMS motor rotor 130 in accordance with the invention. FIG. 1b shows scanning probe microscope cantilever 150 attached to electrostatic MEMS motor rotor 130 in contact with surface 120. Scanning probe microscope cantilever 150 is attached to electrostatic MEMS motor rotor 130 such that scanning probe microscope cantilever 150 extends past the boundary of electrostatic MEMS motor rotor 130 to allow the use of, for example, an optical lever technique to monitor the vertical position of scanning probe tip 155.

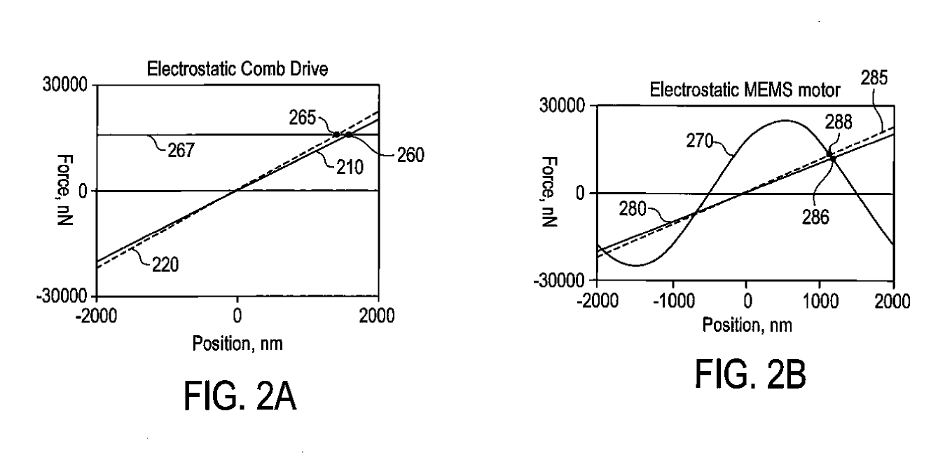

Other MEMS actuators may be used in accordance with the invention. For example, an electrostatic comb drive may be used in place of electrostatic MEMS motor 135. FIG. 1c shows scanning probe microscope cantilever 150 attached to electrostatic comb drive rotor 182 of electrostatic comb drive 180 in accordance with the invention. Scanning probe microscope cantilever 150 is attached to electrostatic comb drive rotor 130 such that scanning probe microscope cantilever 150 extends past the boundary of electrostatic comb drive rotor 182 to allow the use of, for example, an optical lever technique to monitor the vertical position of scanning probe tip 155. FIG. 1d shows scanning probe microscope cantilever 150 attached to electrostatic comb drive rotor 182 of electrostatic comb drive 180 in contact with surface 120 The particular electrostatic MEMS actuator selected effects the relationship between the measured frequencies and the spring constant, κₜᵢₚ, of scanning microscope cantilever 150. FIGS. 1a and 1b show electrostatic MEMS motor 135 which is a surface drive actuator while FIGS. 1c and 1d show electrostatic comb drive 180. FIGS. 2a and 2b show force versus position curves for electrostatic comb drive 180 and electrostatic MEMS motor rotor 135, respectively. For both electrostatic comb drive 180 and electrostatic MEMS motor 135, the force versus position curves are the sum of three components: the force of springs 140 or springs 186 that constrain electrostatic MEMS motor rotor 130 or electrostatic comb drive rotor 182; the electrostatic force generated by electrostatic MEMS motor rotor 130 or electrostatic comb drive rotor 182; and the force from scanning probe microscope cantilever 150 or scanning probe microscope cantilever 150, respectively. The force from scanning probe microscope cantilever 150 is present only if scanning probe tip 155 interacts with surface 120.

For electrostatic comb drive 180 as described by, for example, R. Legtenberg, A. W. Groeneveld and M. Elwenspoek in “Comb-drive actuators for large displacements”, Journal of Micromechanics and Microengineering, 6, pp. 320-329, 1996, incorporated herein by reference, the electrostatic force can be approximated as follows:

$$F \approx \frac{{ɛ}_{0} {LV}_{applied}^{2}}{d} \qquad ( 4 )$$

where L is the sum of the thicknesses of all comb fingers 185 in electrostatic comb drive 180. From Equation (4), it can be seen that the electrostatic force, F, is essentially independent of position. At equilibrium, the electrostatic force is equal to and the negative of the spring forces contributed by springs 186 and scanning probe microscope cantilever 150. This allows the rest position of electrostatic comb drive 180 to be determined by considering where the negative of the spring forces are substantially equal to the force generated by electrostatic comb drive 180. In FIG. 2a, curve 210 shows the negative of the spring forces as a function of position when scanning probe tip 150 is not in contact with surface 120 and curve 220 shows the negative spring forces as a function of position when scanning probe tip is in contact with surface 120. When scanning probe microscope cantilever 150 is not in contact with surface 120, the equilibrium position of electrostatic comb drive 180 is shown by non-contact point 260 in FIG. 2a. When scanning probe tip 150 is in contact with surface 120, an additional spring force is added due to the spring force contributed by scanning probe microscope cantilever 155 and the equilibrium position of electrostatic comb drive 180 moves and is shown by contact point 265 in FIG. 2a. Because force curve 267 for electrostatic comb drive 180 is essentially independent of position, changes in resonant frequency are due to the spring force contributed by scanning probe microscope cantilever 155 when scanning probe tip 150 is in contact with surface 120.

For electrostatic MEMS motor 135 as described in, for example, U.S. Pat. No. 5,986,381, incorporated by reference, the electrostatic force is not independent of position. The electrostatic force is typically periodic with the rotor position and for electrostatic MEMS motor rotor 130 the electrostatic force is a sinusoidal function of position as shown by curve 270 in FIG. 2b. The amplitude of the electrostatic force depends on the applied voltage and the position of the zero crossing depends on the specific voltage pattern applied to electrostatic MEMS motor 135. In FIG. 2b, the variation of the force of springs 140 with position is shown by curve 280 and the force of springs 140 plus the force due to the contact of scanning probe tip 155 in contact with surface 120 with position is shown by curve 285. Electrostatic MEMS motor 135 is at rest in equilibrium position 286 when scanning probe tip 155 is not in contact with surface 120. Equilibrium position 286 occurs where curve 280 intersects curve 270. When scanning probe tip 155 is in contact with surface 120, an additional spring force due to scanning microscope cantilever 150 results in new equilibrium position 288 which is where curve 285 intersects curve 270. Equilibrium position 286 and the associated resonance frequency depend on the functional form of the electrostatic force curve. For small changes in position as shown in FIG. 2b, electrostatic force curve 270 can be approximated as a straight line.

Note, for the purposes of this description, contact between scanning probe tip 155 and surface 120 is defined as when the vertical position of scanning probe tip 155 is to the left of inflection point 199 of probe-surface interaction force 198 as shown in FIG. 1e which plots sensor position versus vertical probe position. Note that the sensor position is proportional to probe-surface interaction force 198. Surface 120 is assumed to be sufficiently “hard” that scanning probe tip 155 moves less than about 10 percent as much as electrostatic MEMS motor rotor 130 or electrostatic comb drive rotor 182 when scanning probe tip 155 is brought in contact with surface 120. The term “sensor position” refers to the position of the reflected optical beam on the bi-cell photodetector as described, for example, in U.S. Pat. No. 5,587,523 incorporated herein by reference. The position of the reflected optical beam can be used to determine the vertical position of scanning probe tip 155. To simplify the discussion, the sensor is positioned so the zero of the sensor position readout corresponds to the situation when there are no surface forces acting on scanning probe tip 155 and corresponds to point 197 in FIG. 1e.

In accordance with the invention, the spring constant, κₜᵢₚ, of scanning microscope cantilever 150 can be determined in accordance with the invention by measuring the displacement of electrostatic MEMS motor rotor 130 or electrostatic comb drive rotor 182 in response to a an applied voltage, V_{applied}. Two displacement measurements are required: a measurement with scanning probe tip 155 in contact with surface 120 and a measurement with scanning probe tip 155 not in contact with surface 120. The displacement may be measured by either a built-in measuring device, such as, for example, a capacitive sensor, or an external measuring device, such as the KEYENCE optical retro-reflective laser displacement sensor. This allows each scanning probe microscope cantilever 150 to be measured individually just prior to use.

In the first of the two measurements, electrostatic MEMS motor rotor 130 or electrostatic comb drive rotor 182 and scanning probe tip 155 are maintained in a completely unloaded state such that scanning probe tip 155 does not contact or interact with surface 120. A constant voltage, V_{applied}, is applied to electrostatic MEMS motor 135 or electrostatic comb drive 180, displacing electrostatic MEMS motor rotor 130 or electrostatic comb drive rotor 182 until the opposing force of springs 140 or springs 186, is substantially equal to and opposite to the force from electrostatic MEMS motor rotor 130 or electrostatic comb drive rotor 182, respectively. For electrostatic MEMS motor rotor 130 or electrostatic comb drive rotor 182, the force from electrostatic MEMS motor rotor 130 or electrostatic comb drive rotor 182 is the result of an applied voltage, however, for other types of MEMS (micro-electromechanical system) actuators in accordance with the invention, such as those employing an electromagnetic drive, the force is the result of the applied current. The resulting displacement, Δx₁, of electrostatic MEMS motor rotor 130 or electrostatic comb drive rotor 182 due to applied voltage, V_{applied}, is determined

In the second of the required measurements, scanning probe tip 155 is positioned with no voltage applied to electrostatic MEMS motor 135 or electrostatic comb drive rotor 182 so that scanning probe tip 155 is in contact with surface 120. Then the same applied voltage, V_{applied}, as before is applied and the resulting displacement, Δx₂, of electrostatic MEMS motor rotor 130 or electrostatic comb drive rotor 182 is determined. This measurement includes an additional spring force due to the bending of scanning probe microscope cantilever 150 because scanning probe tip 155 is now in contact with surface 120. The additional spring force now results in a smaller displacement Δx₂, of electrostatic MEMS motor rotor 130 or electrostatic comb drive rotor 182. The two displacements, Δx₁ and Δx₂, allow the spring constant, κₜᵢₚ, of scanning microscope cantilever 150 to be determined in accordance with the invention provided that the spring constant, κₘ, of springs 140 or springs 186 is known. Methods for determining κₘ are discussed below. Note that this method in accordance with the invention can be used with other suitable MEMS actuators.

Alternatively, the relationship of the applied voltage to the displacement of electrostatic MEMS motor rotor 130 or electrostatic comb drive rotor 182 when there is no contact with surface 120 may be predetermined and the relevant data, for example, stored in a lookup table or used to construct an empirical function fit. The lookup table may be stored in the memory of an electronic processor. This allows the resulting displacement to be determined for any applied voltage in the no contact state. Scanning probe tip 155 is positioned with no voltage applied to electrostatic MEMS motor 135 or electrostatic comb drive rotor 182 so that scanning probe tip 155 is in contact with surface 120. Then an applied voltage, V_{applied}, is applied and the resulting displacement, Δx₂, of electrostatic MEMS motor rotor 130 or electrostatic comb drive rotor 182 is determined as above. The displacement, Δx₁, of electrostatic MEMS motor rotor 130 or electrostatic comb drive rotor 182 when there is no contact with surface 120 is then obtained from the lookup table or from the empirical function fit for the applied voltage, V_{applied}. The two displacements, Δx₁ and Δx₂, allow the spring constant, κₜᵢₚ, of scanning microscope cantilever 150 to be determined in accordance with the invention provided that the spring constant, κₘ, of springs 140 or springs 186 is known. Methods for determining κₘ are discussed below. Note that this method in accordance with the invention can be used with other suitable MEMS actuators.

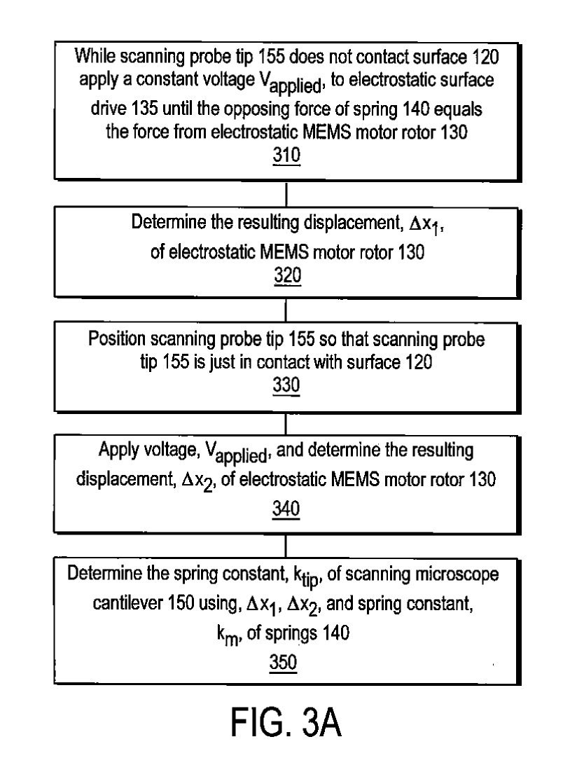

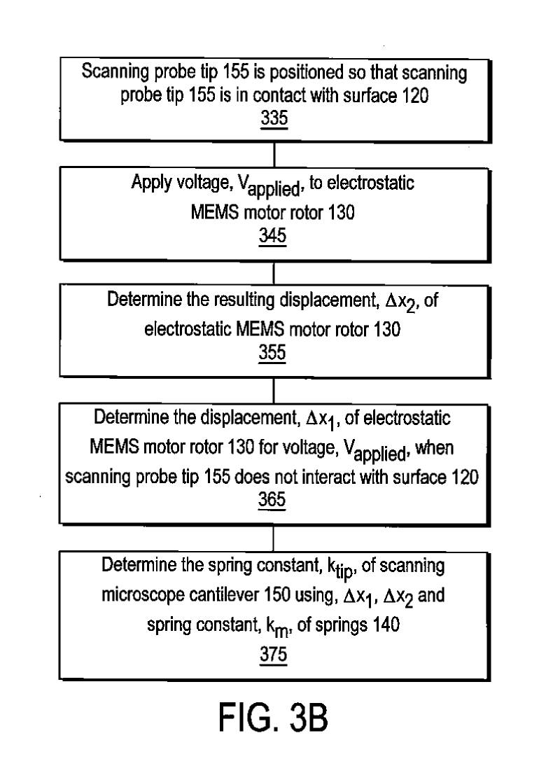

FIG. 3a shows the steps of an embodiment in accordance with the invention. In step 310, apply a constant voltage, V_{applied}, to electrostatic MEMS motor 135 until the opposing force of springs 140 substantially equals the force from electrostatic MEMS motor rotor 130 and any oscillations have died out. In step 320, the displacement, Δx₁, of electrostatic MEMS motor rotor 130 is determined. In step 330, scanning probe tip 155 is positioned so that scanning probe tip is in contact with surface 120. Then in step 340, the voltage, V_{applied}, is applied to electrostatic MEMS motor 135 and the displacement, Δx₂, of electrostatic MEMS motor rotor 130 is determined. In step 350, the spring constant, κₜᵢₚ, of scanning microscope cantilever 150 is determined using Δx₁, Δx₂, the spring constant, κₘ, of springs 140 and the shape of force curve 270. For electrostatic comb drive 180, electrostatic comb drive rotor 182 replaces electrostatic MEMS motor rotor 130 in the above discussion of FIG. 3a.

FIG. 3b shows the steps of an embodiment in accordance with the invention. In step 335, scanning probe tip 155 is positioned so that scanning probe tip 155 is in contact with surface 120. Then in step 345, the voltage, V_{applied}, is applied to electrostatic MEMS motor 135. In step 355, the displacement, Δx₂, of electrostatic MEMS motor rotor 130 is determined. In step 365, the displacement, Δx₁, of electrostatic MEMS motor rotor 130 is determined for the applied voltage, V_{applied}, when scanning probe tip 155 does not interact with surface 120. In step 375, the spring constant, κₜᵢₚ, of scanning microscope cantilever 150 is determined using Δx₁, Δx₂, the spring constant, κₘ, of springs 140 and the shape of force curve 270. For electrostatic comb drive 180, electrostatic comb drive rotor 182 replaces electrostatic MEMS motor rotor 130 in the above discussion of FIG. 3b.

There are a number of ways to obtain the spring constant, κₘ, of springs 140 or springs 186 in accordance with the invention. κₘ may be measured directly using a force and displacement measuring device where a given force is applied to electrostatic MEMS motor rotor 130 or electrostatic comb drive rotor 182 and the resulting displacement is measured. The force, F, may be applied by pushing on electrostatic MEMS motor rotor 130 or electrostatic comb drive rotor 182 with a calibrated micro-force sensor while the displacement, Δy, is measured optically using a KEYENCE optical retro-reflective laser displacement sensor so that no external loading is introduced and κₘ=F/Δy. Alternatively, the force, F, can be calculated from the known geometry of electrostatic MEMS motor 135 or electrostatic comb drive 180 and the applied voltage, V_{applied}, as the force, F, is typically proportional to the applied voltage, V_{applied}.

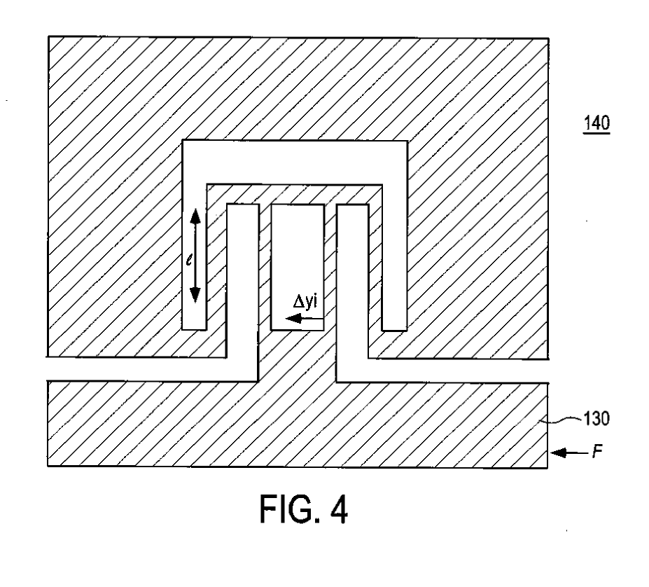

κₘ may be calculated from the dimensions of springs 140 of electrostatic MEMS motor rotor 130 and knowledge of Young's modulus, E, for the spring material. For example, with reference to FIG. 4, for one spring 140 of electrostatic MEMS motor rotor 130, the deflection Δyᵢ is given by:

$$Δ {y}_{i} = \frac{{Fl}^{3}}{12 EI} \qquad ( 4 )$$

where l is the spring length and I is the moment of inertia of the spring cross-section. For electrostatic MEMS motor rotor 130 which has ten springs 140:

$$Δ y = \frac{5 {Fl}^{3}}{6 EI} \qquad ( 5 )$$

so that:

$${κ}_{m} = \frac{6 EI}{5 {l}^{3}} \qquad ( 6 )$$

Similarly, for electrostatic comb drive 180 (see FIG. 1c), κₘ, be calculated from the dimensions of springs 186 and knowledge of Young's modulus, E, for the spring material. This gives:

$${κ}_{m} = \frac{2 EI}{{l}^{3}} \qquad ( 7 )$$

for the two springs of FIG. 1c, where l is the spring length and I is the moment of inertia of the spring cross-section.

κₘ may also be calculated by measuring the resonance frequency, ωₙ, of springs 140 or springs 186 and the mass, mᵣ, of electrostatic MEMS motor rotor 130 or electrostatic comb drive rotor 182 which may include the mass of springs 140 or springs 186, respectively, if significant. It is typically difficult to measure the mass of electrostatic MEMS motor rotor 130 or electrostatic comb drive rotor 182. The mass may be calculated from the volume which is measurable or electrostatic MEMS motor rotor 130 or electrostatic comb drive rotor 182 may be detached and weighed. Typically, the variation in mass from one electrostatic MEMS motor rotor 130 or electrostatic comb drive rotor 182 to another within a wafer is small and the largest variation is due to the variable thickness between different wafers. The spring constant is highly variable between wafers because it depends on the cube of the width of springs 140 or springs 186 and varies due to processing. The resonance frequency, ωₙ, may be measured by observing the response of electrostatic MEMS motor rotor 130 or electrostatic comb drive rotor 182 to a step, pulse or swept-sine forcing function. Measurement of the resonance frequency, ωₙ, is performed using a sensor which does not affect the result such as an optical or capacitive sensor.

In particular, one way to determine the resonance frequency, ωₙ, of electrostatic MEMS rotor motor 130 is to apply a low voltage sine wave, typically about 0.025 of the overall bias voltage, to the disruptor electrode (not shown, see for example, U.S. Pat. No. 5,986,381) of electrostatic motor 135. The voltage signal from the capacitive position sensor (not shown) is then multiplied by the applied sine wave voltage and averaged over several periods to produce a sine mixed signal. The voltage signal from the capacitive position sensor is also multiplied by a signal that is 90 degrees out of phase with the applied sine wave voltage and average over several periods to produce a cosine mixed signal. The sine mixed signal is combined in quadrature with the cosine mixed signal to give the signal magnitude. The frequency of the applied sine wave voltage is then typically varied by several hertz to determine the signal magnitude as a function of frequency. The resonant frequency occurs when the signal magnitude is a maximum. Alternatively, the resonant frequency may be found by noting the frequency where the sine mixed signal crosses zero.

Similar methods for determining the resonance frequency, ωₙ, may be used for other MEMS actuators such as electrostatic comb drive 180.

Because applying a voltage to electrostatic MEMS motor rotor 130 or electrostatic comb drive rotor 182 typically increases the apparent suspension stiffness, the same voltage, V_{applied}, should be applied to electrostatic MEMS motor rotor 130 or electrostatic comb drive rotor 182 during the measurement. An estimate of the effective spring constant, κₘ, for springs 140 or springs 186 is then:

κₘ≅mᵣωₙ² (8)

where mᵣ is the mass of either electrostatic MEMS motor rotor 130 or electrostatic comb drive rotor 182 and ωₙ is the resonance frequency of either electrostatic MEMS motor rotor 130 or electrostatic comb drive rotor 182, respectively.

Note that in this embodiment in accordance with the invention, the effective spring constsnt, κₘ, includes the effects of both the applied voltage, V_{applied} and springs 140 or springs 186 for electrostatic MEMS motor rotor 130 or electrostatic comb drive rotor 182, respectively.

Once the effective spring constant, κₘ, of electrostatic MEMS motor rotor 130 or electrostatic comb drive rotor 182 is known, the spring constant, κₜᵢₚ, of scanning microscope cantilever 150 can be determined in accordance with the invention by the following:

κₜᵢₚ=κₘ((Δx₁/Δx₂)−1) (9)

where Δx₁ and Δx₂ are as defined above. The examples of electrostatic MEMS motor 135 and electrostatic comb drive 180 are merely illustrative and the method described above applies to other suitable MEMS actuators.

Alternatively, because for electrostatic comb drive 180 the electrostatic force is independent of position as seen in FIG. 2a, the second measurement above can be modified for electrostatic comb drive 180 by applying a different forcing voltage, V_{f}, when scanning probe tip 155 is just in contact with surface 120 that achieves the same displacement Δx₁ as in the first measurement. Then

κₜᵢₚ=κₘ((V_{applied}/V_{f})−1) (10)

While the invention has been described in conjunction with specific embodiments, it is evident to those skilled in the art that many alternatives, modifications, and variations will be apparent in light of the foregoing description. Accordingly, the invention is intended to embrace all other such alternatives, modifications, and variations that fall within the spirit and scope of the appended claims.

1. A method for determining a spring constant of a scanning probe microscope cantilever mechanically coupled to a MEMS actuator having an actuator spring constant comprising:
bringing a scanning probe tip mechanically coupled to said scanning probe microscope cantilever in contact with a surface;
applying a constant voltage to said MEMS actuator and determining a second displacement of said MEMS actuator;
determining a first displacement of said MEMS actuator from said constant voltage; and
determining said spring constant using said first displacement, said second displacement and said actuator spring constant.

2. The method of claim 1 wherein said first displacement is determined from said constant voltage by using a lookup table comprised of displacements and voltages.

3. The method of claim 2 wherein said lookup table is stored in a memory of an electronic processor.

4. The method of claim 1 wherein said actuator spring constant is measured.

5. The method of claim 1 wherein said is actuator spring constant calculated.

6. The method of claim 5 wherein said actuator spring constant is calculated using a resonance frequency.

7. The method of claim 6 wherein said resonance frequency is measured by observing a response of said MEMS actuator to a forcing function selected from a group consisting of a step function, a pulse function and a swept-sine function.

8. The method of claim 5 wherein said actuator spring constant is calculated using a Young's modulus.

9. The method of claim 1 wherein said MEMS actuator comprises an electrostatic MEMS motor rotor.

10. The method of claim 1 wherein said MEMS actuator comprises an electrostatic comb drive rotor.

11. The method of claim 1 wherein said MEMS actuator comprises an electromagnetic drive.

12. A method for determining a spring constant of a scanning probe microscope cantilever mechanically coupled to an electrostatic MEMS motor rotor having an actuator spring constant comprising:
applying a constant voltage to said electrostatic MEMS motor rotor until a force of said electrostatic MEMS motor rotor is substantially equal and opposite to a restoring force of said electrostatic MEMS motor rotor;
determining a first displacement of said electrostatic MEMS motor rotor;
bringing a scanning probe tip mechanically coupled to said scanning probe microscope cantilever in contact with a surface;
applying said constant voltage to said electrostatic MEMS motor rotor and determining a second displacement of said electrostatic MEMS motor rotor; and
determining said spring constant using said first displacement, said second displacement and said actuator spring constant.

13. The method of claim 12 wherein said is actuator spring constant calculated.

14. The method of claim 13 wherein said actuator spring constant is calculated using a resonance frequency.

15. The method of claim 14 wherein said resonance frequency is measured by observing a response of said electrostatic MEMS motor rotor to a forcing function selected from a group consisting of a step function, a pulse function and a swept-sine function.

16. The method of claim 13 wherein said actuator spring constant is calculated using a Young's modulus.

17. A method for determining a spring constant of a scanning probe microscope cantilever mechanically coupled to an electrostatic comb drive rotor having an actuator spring constant comprising:
applying a first voltage to said electrostatic comb drive rotor until a force of said electrostatic comb drive rotor is substantially equal and opposite to a restoring force of said electrostatic comb drive rotor;
determining a first displacement of said electrostatic comb drive rotor;
bringing a scanning probe tip mechanically coupled to said scanning probe microscope cantilever in contact with a surface;
applying a second voltage to said electrostatic comb drive rotor to produce a second displacement of said electrostatic comb drive rotor substantially equal to said first displacement; and
determining said spring constant using said first voltage, said second voltage and said actuator spring constant.

18. The method of claim 17 wherein said is actuator spring constant calculated.

19. The method of claim 18 wherein said actuator spring constant is calculated using a resonance frequency.

20. The method of claim 19 wherein said resonance frequency is measured by observing a response of said electrostatic MEMS motor rotor to a forcing function selected from a group consisting of a step function, a pulse function and a swept-sine function.

21. The method of claim 18 wherein said actuator spring constant is calculated using a Young's modulus.

22. The method of claim 17 wherein said actuator spring constant is measured.
